(19) United States
(12) Patent Application Publication
(10) Pub. No.: US 2026/0131641 A1
(43) Pub. Date: May 14, 2026

(54) MAGNETIC SPLITTABLE SUN VISOR

(71) Applicant: Tesla, Inc., Austin, TX (US)

(72) Inventors: Devan Maximo Wiitala, Hayward, CA (US); Yiqing Wang, San Jose, CA (US); Viorel Bagdan Grosu, Alameda, CA (US)

(21) Appl. No.: 18/947,696

(22) Filed: Nov. 14, 2024

(51) Int. Cl. B60J 3/02

(52) U.S. Cl. CPC B60J 3/0278; B60J 3/0256; B60J 3/026

(57) ABSTRACT

An automotive sun visor includes a first panel having a first height and a first length, a second panel having a second height and a second length, a panel coupling mechanism including at least one magnet or ferromagnetic element at a inboard edge of the first panel and at least one magnet or ferromagnetic element at a inboard edge of the second panel, the mechanism configured to detachably couple the first panel to the second panel at the inboard edges, via the magnets, to form the automotive sun visor, the sun visor configured to extend along a length of a front windshield, and the first panel configured to extend along at least a portion of a length of a side window when detached from the second panel.

### TECHNICAL FIELD

This disclosure relates to sun visors and more particularly, but not exclusively, to a splittable sun visor.

### BACKGROUND

Sun visors have become an integral component of vehicle interiors, serving a primary function of protecting the driver's and passengers' eyes from the glare of the sun. This glare can be a significant hazard, as it can impair the driver's vision, leading to discomfort and potentially dangerous driving conditions. The design and functionality of sun visors have evolved over time to meet various needs, including aesthetic preferences, safety regulations, and ergonomic considerations.

Traditionally, sun visors have been designed as flat panels that can be flipped down or rotated to block sunlight from the front or side windows. They are typically mounted above the windshield on a swivel that allows for this movement. The materials used in their construction have varied, with early models often made from simple, rigid materials that provided basic functionality without much consideration for the interior design of the vehicle.

As automotive design has progressed, the integration of sun visors into the vehicle's overall aesthetic has become more important. Designers have sought to create sun visors that not only perform their intended function but also blend seamlessly with the rest of the vehicle's interior. This has led to the exploration of various materials and shapes that can contribute to a more luxurious and cohesive look.

The challenge of providing adequate visibility while minimizing the obstruction of the driver's field of view has been a constant concern in sun visor design. The size and shape of sun visors must be carefully considered to ensure they can effectively block sunlight without becoming a visual impediment themselves. This balance is crucial for maintaining safety standards while also delivering comfort and convenience to the occupants of the vehicle.

Another consideration in the design of sun visors is their impact on the vehicle's interior space. As vehicles have become more compact, the need to maximize headroom and maintain an open, airy cabin has grown. This has led to efforts to reduce the thickness and profile of sun visors, making them less intrusive while still providing the necessary sun-blocking function.

Durability and ease of use are also key factors in the development of sun visors. They are frequently handled and adjusted, often in quick, sometimes forceful movements as drivers react to changing light conditions. As such, the mechanisms that allow for the movement and positioning of sun visors must be robust and able to withstand repeated use over the life of the vehicle.

In addition to their primary function, sun visors have also been adapted to include additional features for the convenience of vehicle occupants. These have included mirrors, typically with a cover that can be opened or closed, and lighting to aid in visibility. The integration of these features has required additional engineering to ensure that the added components do not compromise the sun visor's functionality or durability.

Overall, the field of sun visor design has been driven by the need to balance functionality with aesthetics, durability with convenience, and space-saving and cost considerations with safety requirements. The evolution of sun visors reflects broader trends in automotive design, where every component seeks to contribute to the vehicle's performance, comfort, and appeal.

### BRIEF DESCRIPTION OF THE DRAWINGS

To easily identify the discussion of any particular element or act, the most significant digit or digits in a reference number refer to the figure number in which that element is first introduced.

FIG. 1 is a pictorial view of some examples motor vehicle interior showing the sun visor in a stowed position flush against the vehicle's headliner, according to some examples.

FIG. 2 is a pictorial view of the example motor vehicle interior showing the sun visor in a deployed position, according to some examples.

FIG. 3 is an exploded view of the sun visor, according to some examples.

FIG. 4 is a pictorial view of the example motor vehicle interior showing the sun visor in a detached mode, according to some examples.

FIG. 5 is a pictorial view of the example motor vehicle interior showing a first panel of the sun visor rotated against a left-side window, according to some examples.

FIG. 6 is a pictorial view of the example motor vehicle interior showing a second panel of the sun visor rotated against a right-side window, according to some examples.

FIG. 7A is an isometric view of the sun visor panels' sweep range, according to some examples.

FIG. 7B is a top view of the sun visor panels' sweep range, according to some examples.

### DETAILED DESCRIPTION

Examples of automotive sun visors are now described that seek to provide enhanced functionality and aesthetic appeal for vehicle interiors. Some examples sun visor comprises two large sun visor halves (panels) that together offer substantial coverage between A-pillars of a vehicle along a top section of a windshield. These sun visor halves can meet underneath a beauty cover in the deployed position and are joined magnetically along a vertical split plane. The sun visor halves can be comfortably separated by a modest amount of force applied by a single hand, and then rotated to the side, granting critical side coverage. Once reset, the sun visor halves snap together, enabling one-piece operation in the front once again. The sun visor may be comprised of a PBT+GF30 core substrate, upon which two wrapped expanded polypropylene (EPP) foam halves are glued. Magnets are inset or overmolded into the core substrate towards the center. A nylon cap is then slid over the end in order to provide the proper friction/durability characteristics at the joined interface. Magnetic center checks can also be used.

The sun visor assembly comprises an elongated, curved panel structure designed to fit seamlessly within the upper interior of a vehicle. The overall shape of the visor is characterized by a gently arched profile along its longitudinal axis, with rounded corners and edges to ensure safety and aesthetic appeal. The visor's cross-sectional profile is not uniform throughout its length. Instead, it tapers slightly from the center towards the outer edges, creating a subtle aerodynamic curvature. This design element not only enhances the visor's visual appeal but also potentially contributes to reduced wind noise when the visor is deployed in its lowered position. The visor assembly is composed of two primary sections, joined along a central axis.

This split design allows for independent adjustment of the driver and passenger sides. The junction between these two sections is not a simple straight line but rather a engineered interface that enables secure connection while facilitating easy separation when needed. The cutaway portions of the visor are strategically located along the edges where the two halves meet. These cutaways are not uniform along the entire edge.

The magnetic coupling mechanism is integrated along a portion of the edge where the two visor sections meet. This partial magnetic coupling system is not continuous along the entire edge but is concentrated in specific areas. The magnets are embedded within the visor's structure, hidden from view. The internal structure of the visor comprises a complex honeycomb-like framework. This design provides structural integrity and rigidity while minimizing the overall weight of the assembly. The honeycomb structure is particularly dense near the edges and mounting points, gradually becoming less dense towards the center of the visor panels.

The visor's mounting mechanism is in the form of brackets and pivoting joints at specific points along the upper edge of the assembly. These mounting points are reinforced internally to withstand the frequent adjustments and forces exerted during normal use.

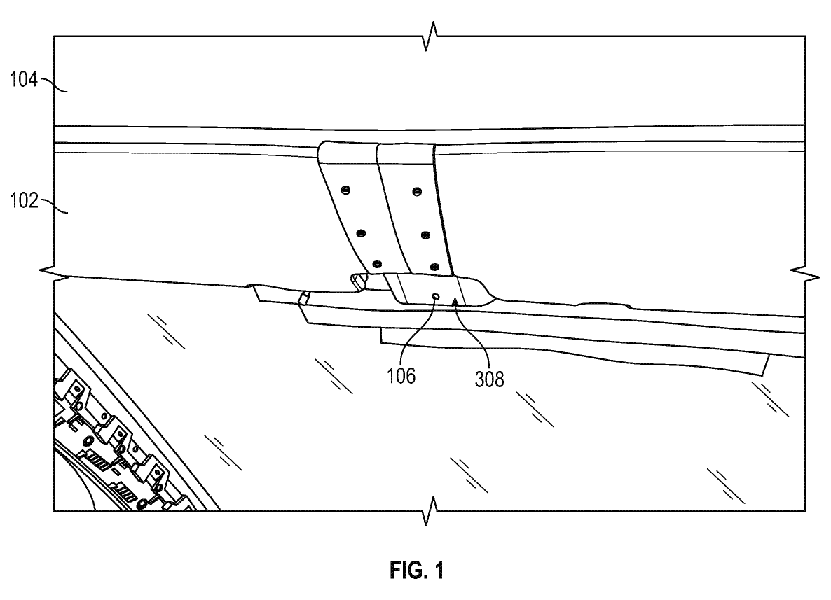

FIG. 1 is a pictorial view of some examples motor vehicle interior showing some examples sun visor 102 lying in a stowed position flush against a headliner 104 of the vehicle interior, according to some examples some examples. The sun visor 102 may include a cutout 308 to enable a sensor 106 to face an operator of the motor vehicle for monitoring purposes (e.g., to monitor sleep/wake state of the operator). The sensor 106 may include, for example, a camera and/or radar. The radar may detect vital signs (e.g., heart rate, respiration rate, etc.) to determine if the vehicle operator is fatigued or sleeping.

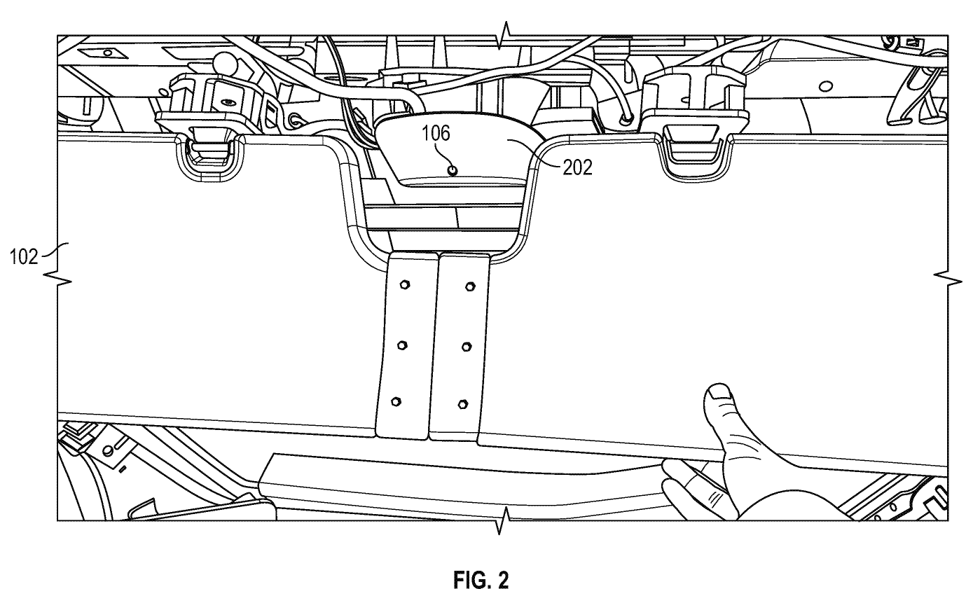

FIG. 2 is a pictorial view of some examples motor vehicle interior showing some examples sun visor 102 lying in a deployed position, some examples according to some examples. The sun visor 102 can rotate at least 90 degrees from being flush with the headliner 104 to parallel with a front windshield 702. Note that a sensor housing 202 may hold a sensor 106. The sensor housing 202 may be shaped similarly to a cutout 308 in the sun visor 102 or otherwise configured such that the sun visor 102 does not overlap with the sensor housing 202.

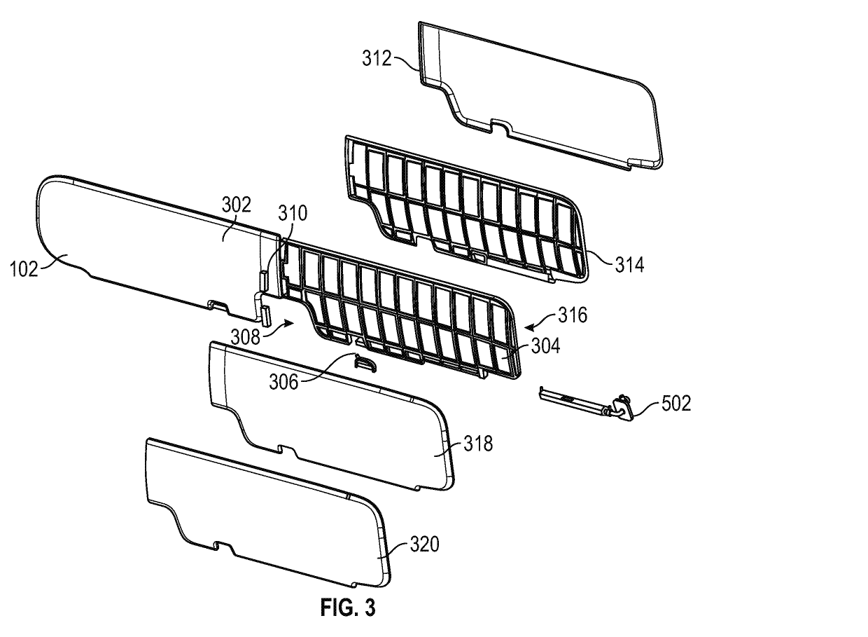

FIG. 3 is an exploded view of the sun visor 102. The sun visor 102 may have a length less than or equal to a length at a top of a front windshield 702, e.g., 1,338 mm. The sun visor 102 comprises a first panel 302 and a second panel 304, which may be of equal length, e.g., 669 mm. The first panel 302 and the second panel 304 may also each have a height of 237 mm and a thickness of 45 mm. The length of the first panel 302 and second panel 304 may each be at least equal to the length of a side window.

The sun visor 102 may also include a panel coupling mechanism including at least one magnet 310 at a first edge of the first panel 302 and at least one magnet at a first edge of the second panel. The mechanism is configured to detachably couple the first panel 302 to the second panel 304 at the edges, via the magnets, to form the automotive sun visor 102. In another example, the mechanism may couple the first panel 302 to the second panel with hook and loop fastener or adhesive.

Each of the first panel 302 and the second panel 304 may be rotatably coupled to the headliner 104 via a pivot 502, which may include a telescoping joint. Additionally, each of the first panel 302 and the second panel 304 may include a magnetic center check 306 to magnetically couple each panel to the headliner 104 when the sun visor 102 is not split. The sun visor 102 may also include a cutout configured to provide a sensor with a view of an operator.

Each panel may be formed from a core substrate 316 surrounded on opposing sides by an expanded polypropylene (EPP) substrate 314 and an EPP substrate 318, which each in turn can be covered with a Polyvinyl Chloride (PVC) wrap 312 and a PVC wrap 320. Other materials may be used in place of or in addition to EPP and PVC. The panels may be formed via injection molding or other technology.

The magnet 310 may be mounted on the core substrate 316 and covered by the EPP substrate 318 and/or the PVC wrap 320. The (at least one) magnet 310 of the first panel 302 and the (at least one) magnet of the second panel are configured to required approximately 12 pounds of force to separate from each other. The magnet 310 of the first panel and the magnet of the second panel are configured to not overlap and may be aligned synchronously with each other on their respective panels. The magnet 310 of the first panel 302 may include a bar magnet running along at least a portion of the height of the first panel 302 and the magnet of the second panel 304 may include a bar magnet running along at least a portion the height of the second panel 304. The magnet 310 of the first panel may include two axially aligned bar magnets extending in series along the first edge of the first panel 302 and the magnet of the second panel 304 may include two axially aligned bar magnets extending in series along the first edge of the second panel.

In some examples, the sun visor 102 may incorporate an integrated display screen capable of showing vehicle data. This screen could function as a hybrid screen/mirror, capable of switching between a reflective surface and a display for presenting information such as local weather, time, state of charge, and regional-specific warnings.

In some examples, the sun visor 102 may include one or more sensors to detect sunlight intensity and direction, allowing for automated adjustment of the first panel 302 and/or second panel 304 for optimal sun protection. In some examples, the sun visor 102 may integrate one or more sensors into the sun visor 102, enhancing driver monitoring capabilities and eliminating the need for the cutout 308.

The surface of the sun visor panels 302 and 304 could incorporate touch-sensitive areas for controlling integrated features like the display screen or vanity lights.

In some examples, the sun visor 102 incorporates electrochromic technology, allowing users to adjust the level of light transmission through the panels. The sun visor 102 may also incorporate sensors to automatically adjust transparency based on brightness (e.g., increasing transparency at night and decreasing transparency when facing sunlight).

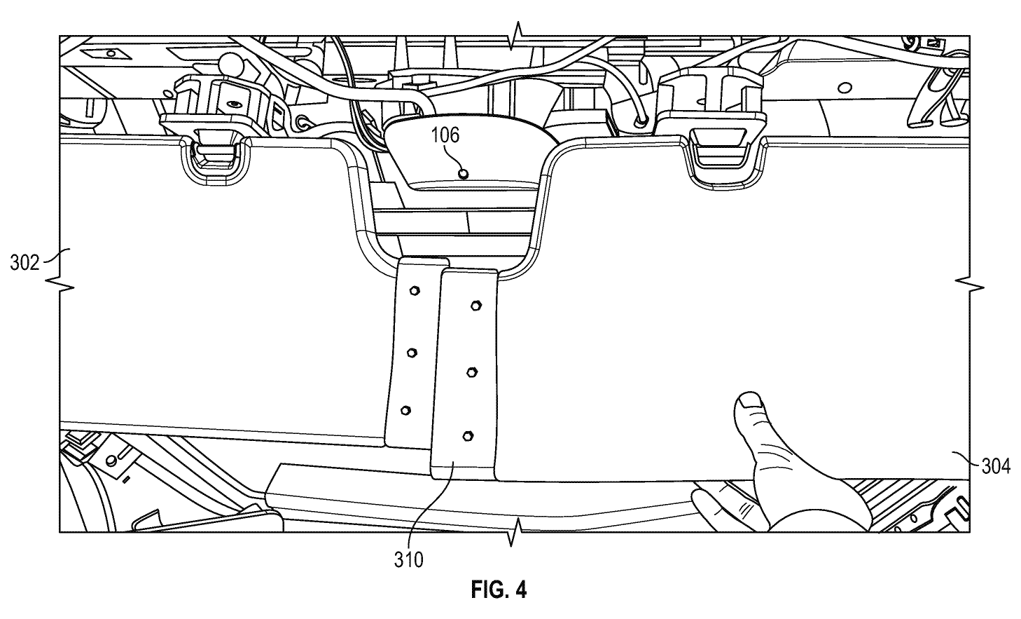

FIG. 4 is a pictorial view of the example motor vehicle interior showing the sun visor 102 in a detached mode, according to some examples.

In this figure, the automotive sun visor 102 is depicted in a state where its two main components, the first panel 302 and the second panel 304, have been separated.

This separation demonstrates the sun visor's splitable functionality, which is a key feature of the described technology.

The figure shows how the panel coupling mechanism, which includes magnets 310 along the edges of each panel, allows for the detachment of the two panels. This detachment is typically achieved by applying approximately 12 pounds of force to overcome the magnetic coupling between the panels.

The separated state of the sun visor panels in FIG. 4 illustrates the system's versatility in providing sun protection. With the panels detached, they can be independently positioned to address various sun glare scenarios. This configuration allows for more targeted sun protection, as each panel can be adjusted separately to block sunlight from different angles.

The figure also implicitly demonstrates the independent rotation capability of each panel, made possible by the separate pivots 502 for each panel. These pivots, which may include telescoping joints, allow each panel to be rotated independently to cover either the front windshield or the side windows as needed.

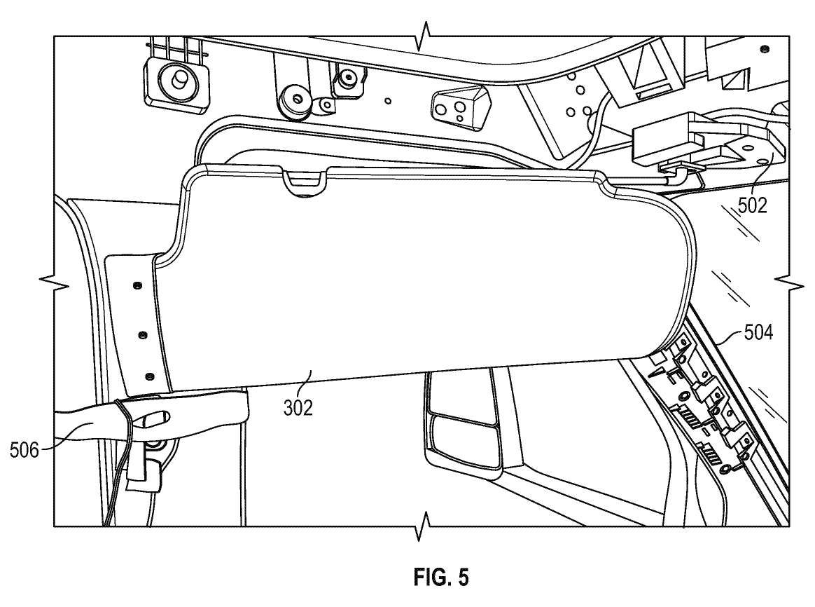

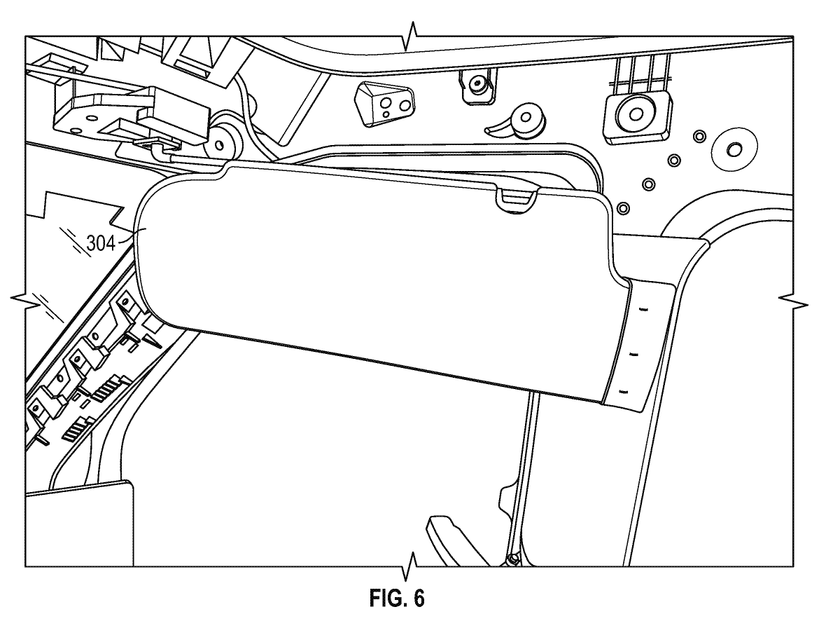

FIG. 4 effectively communicates the transition state between full windshield coverage and individual side window protection, showcasing the adaptive nature of the automotive sun visor system, according to some examples. This detached mode is a crucial step in the process of reconfiguring the sun visor from front windshield protection to side window coverage, as shown in subsequent figures like FIGS. 5 and 6.

FIG. 5 is a pictorial view of the example motor vehicle interior showing the first panel 302 of the sun visor 102 rotated against a left side window, according to some examples. In this figure, the first panel 302 of the automotive sun visor 102 is depicted in a rotated position, providing sun protection for the left side window 504 of the vehicle.

The first panel 302 has been detached from the second panel (not visible in this view) using the panel coupling mechanism. This mechanism, which includes magnets 310 along the edges of each panel, allows for easy separation of the two panels.

The figure showcases the independent rotation capability of the first panel 302, made possible by its rotatable coupling to the vehicle's roof. This coupling is achieved via a pivot 502, which may include a telescoping joint for additional adjustability.

The pivot allows the panel to rotate from its original position parallel to the front windshield to a position covering the side window.

FIG. 5 effectively illustrates how the sun visor system can adapt to provide sun protection for the driver's side of the vehicle, according to some examples. This configuration is particularly useful for blocking low-angle sunlight coming from the side, which can cause significant glare and discomfort for the driver.

The positioning of the first panel 302 against the left side window 504 also implicitly demonstrates the sun visor's ability to maintain its functionality even when split. This feature enhances the system's flexibility in addressing various sun glare scenarios encountered during different times of the day or in different driving directions.

FIG. 6 is a pictorial view of the example motor vehicle interior showing the second panel 304 of the sun visor 102 rotated against a right-side window. FIG. 6 is substantially similar to FIG. 5 and therefore, for purposes of brevity, will not be described in further detail.

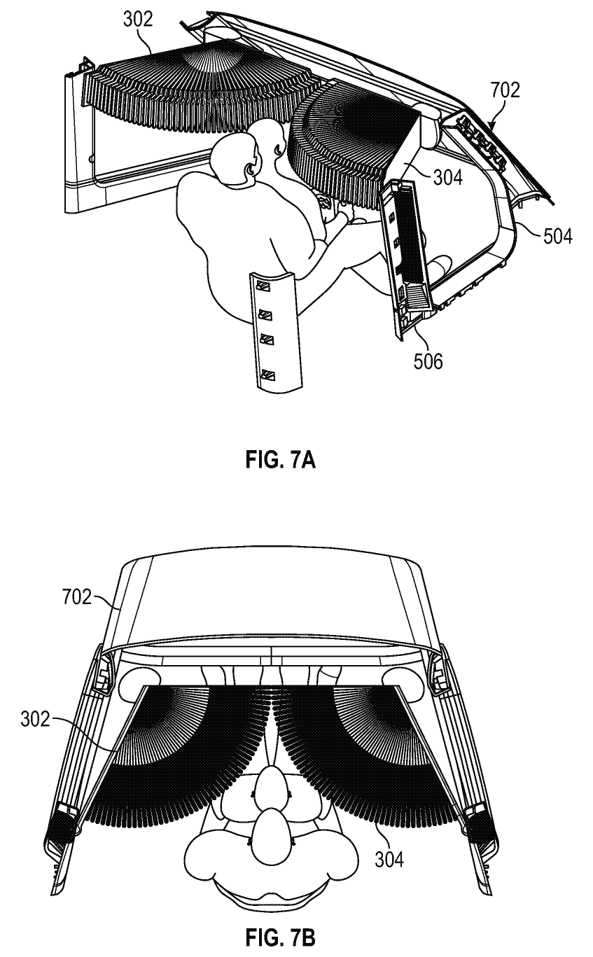

FIG. 7A is an isometric view of the sun visor panels' sweep range and FIG. 7B is a top view of the sun visor panels' sweep range, according to some examples. The diagrams depict the automotive sun visor 102 in various positions, showcasing its range of motion and versatility in providing sun protection. The sun visor 102 comprises two main components: a first panel 302 and a second panel 304.

Each panel is rotatably coupled to the vehicle's headliner 104 via a pivot 502. This pivot may incorporate a telescoping joint, allowing for both rotational movement and linear adjustment. The diagram illustrates how these pivots enable the panels to rotate from a stowed position flush against the headliner to various deployed positions.

The sun visor 102 can rotate at least 90 degrees from being flush with the headliner 104 to parallel with the front windshield 702. This range of motion is crucial for providing effective sun glare protection for the front windshield area.

In addition to the front windshield protection, the diagram shows how the panels can be separated and rotated independently. The first panel 302 is depicted rotating towards the left side window 504, while the second panel 304 is shown rotating towards the right-side window 506. This independent rotation capability allows for versatile sun protection for both the driver and passenger sides of the vehicle or to the left and right of the driver if the vehicle is configured for the driver to sit along the centerline of the vehicle.

The isometric view provides a clear visualization of how the sun visor system can adapt to various sun angles and positions throughout the day. It demonstrates the system's ability to provide comprehensive coverage for both the front windshield and side windows without the need for separate visors or complex mechanisms.

The diagram also implicitly illustrates the functionality of the panel coupling mechanism, which allows the panels to be joined for full windshield coverage and separated for side window protection. While not explicitly shown, this mechanism likely involves the magnets 310 described in the system's construction.

FIGS. 7A and 7B effectively communicate the operational flexibility of the automotive sun visor system, showcasing its ability to address various sun glare scenarios encountered during vehicle operation. The diagram supports the understanding of how the sun visor's design enhances both functionality and user experience in managing sun glare protection.

### EXAMPLES

Thus, some embodiments may include one or more of the following examples.

1. A magnetic splittable sun visor comprising:

a first panel having a first height and a first length;

a second panel having a second height and a second length;

a panel coupling mechanism including magnets or ferromagnetic elements at a first edge of the first panel and at a first edge of the second panel, the mechanism configured to detachably couple the first panel to the second panel at the edges, via the magnets or ferromagnetic elements, to operatively form a unified sun visor;

wherein the first panel and the second panel are configured to detach from each other to operatively form separable left and right side visors.

2. The magnetic splittable sun visor of example 1, wherein the first panel and the second panel each include a magnetic center check to maintain alignment when attached.

3. The magnetic splittable sun visor of any of the preceding examples, wherein the first panel and the second panel are configured to rejoin magnetically at any point along their respective edges.

4. The magnetic splittable sun visor of any of the preceding examples, wherein the first panel and the second panel each include a telescoping mechanism to extend their lengths for additional coverage.

5. The magnetic splittable sun visor of example 4, wherein the first panel and the second panel each include a friction mechanism to maintain alignment between the first and second panels while stowed or deployed.

6. The magnetic splittable sun visor of any of the preceding examples, wherein the first panel and the second panel each include a protective coating to reduce glare and enhance durability.

7. The magnetic splittable sun visor of any of the preceding examples, wherein the first panel and the second panel are configured to be stowed flush against the vehicle's headliner when not in use.

8. The magnetic splittable sun visor of any of the preceding examples, wherein the first panel and the second panel each include a handle for ease of operation.

9. The automotive sun visor of any of the preceding examples, wherein the sun visor includes a cutout to provide a sensor with a view of an operator.

10. The magnetic splittable sun visor of any of the preceding examples, wherein the first panel and the second panel are configured to be easily operated by a single hand (e.g., by about 12 pounds of force).

11. A system, comprising:

a sensor housing;

a sensor mounted within the sensor housing and configured to face an operator; and

a sun visor including

a first panel having a first height and a first length;

a second panel having a second height and a second length;

a panel coupling mechanism including correlated magnets at a first edge of the first panel and at a first edge of the second panel, the mechanism configured to detachably couple the first panel to the second panel at the edges, via the correlated magnets, to operatively form a unified sun visor;

wherein the first panel and the second panel are configured to detach from each other to operatively form separable left and right side visors.

12. The system of example 11, wherein the first panel and the second panel each include a magnetic center check to maintain alignment when attached.

13. The system of any of the preceding examples, wherein the first panel and the second panel are configured to rejoin magnetically at any point along their respective edges.

14. The system of any of the preceding examples, wherein the first panel and the second panel each include a telescoping mechanism to extend their lengths for additional coverage.

15. The system of example 14, wherein the first panel and the second panel each include a friction mechanism to maintain alignment between the first and second panels while stowed or deployed.

16. The system of any of the preceding examples, wherein the first panel and the second panel each include a protective coating to reduce glare and enhance durability.

17. The system of any of the preceding examples, wherein the first panel and the second panel are configured to be stowed flush against the vehicle's headliner when not in use.

18. The system of any of the preceding examples, wherein the first panel and the second panel each include a handle for ease of operation.

19. The system of any of the preceding examples, wherein the sun visor includes a cutout to provide a sensor with a view of an operator.

20. The system of any of the preceding examples, wherein the first panel and the second panel are configured to be easily operated by a single hand.

While the above is a detailed description of the example embodiments of the inventive subject matter, various alternatives, modifications, and equivalents may be used. Therefore, the above description should not be taken as limiting the scope of the inventive subject matter which is defined by the appended claims.

It should be noted that the description and the figures above merely illustrate the principles of the present subject matter along with examples described herein and should not be construed as a limitation to the present subject matter. It is thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

It should be emphasized that many variations and modifications may be made to the above-described examples, the elements of which are to be understood as being among other acceptable examples. All such modifications and variations are intended to be included herein within the scope of this disclosure.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A magnetic splittable sun visor comprising:
a first panel having a first height and a first length;
a second panel having a second height and a second length; and
a panel coupling mechanism including magnets at a first edge of the first panel and at a first edge of the second panel, the mechanism configured to detachably couple the first panel to the second panel at the edges, via the correlated magnets, to operatively form a unified sun visor;
wherein the first panel and the second panel are configured to detach from each other to operatively form separable left and right side visors.

2. The magnetic splittable sun visor of claim 1, wherein the first panel and the second panel each include a magnetic center check to maintain alignment when attached.

3. The magnetic splittable sun visor of claim 1, wherein the first panel and the second panel are configured to rejoin magnetically at any point along their respective edges.

4. The magnetic splittable sun visor of claim 1, wherein the first panel and the second panel each include a telescoping mechanism to extend their lengths for additional coverage.

5. The magnetic splittable sun visor of claim 4, wherein the first panel and the second panel each include a friction mechanism to maintain alignment between the first and second panels while stowed or deployed.

6. The magnetic splittable sun visor of claim 1, wherein the first panel and the second panel each include a protective coating to reduce glare and enhance durability.

7. The magnetic splittable sun visor of claim 1, wherein the first panel and the second panel are configured to be stowed flush against a vehicle's headliner when not in use.

8. The magnetic splittable sun visor of claim 1, wherein the first panel and the second panel each include a handle for ease of operation.

9. The magnetic sun visor of claim 1, wherein the sun visor includes a cutout to provide a sensor with a view of an operator.

10. The magnetic splittable sun visor of claim 1, wherein the first panel and the second panel are configured to be easily operated by a single hand.

11. A system, comprising:
a sensor housing;
a sensor mounted within the sensor housing and configured to face an operator; and
a sun visor including:
a first panel having a first height and a first length;
a second panel having a second height and a second length; and
a panel coupling mechanism including magnets at a first edge of the first panel and at a first edge of the second panel, the mechanism configured to detachably couple the first panel to the second panel at the edges, via the correlated magnets, to operatively form a unified sun visor;
wherein the first panel and the second panel are configured to detach from each other to operatively form separable left and right side visors.

12. The system of claim 11, wherein the first panel and the second panel each include a magnetic center check to maintain alignment when attached.

13. The system of claim 11, wherein the first panel and the second panel are configured to rejoin magnetically at any point along their respective edges.

14. The system of claim 11, wherein the first panel and the second panel each include a telescoping mechanism to extend their lengths for additional coverage.

15. The system of claim 14, wherein the first panel and the second panel each include a friction mechanism to maintain alignment between the first and second panels while stowed or deployed.

16. The system of claim 11, wherein the first panel and the second panel each include a protective coating to reduce glare and enhance durability.

17. The system of claim 11, wherein the first panel and the second panel are configured to be stowed flush against a vehicle's headliner when not in use.

18. The system of claim 11, wherein the first panel and the second panel each include a handle for ease of operation.

19. The system of claim 11, wherein the sun visor includes a cutout to provide a sensor with a view of an operator.

20. The system of claim 11, wherein the first panel and the second panel are configured to be easily operated by a single hand.
